(19) United States
(12) Patent Application Publication
(10) Pub. No.: US 2025/0113358 A1
(43) Pub. Date: Apr. 3, 2025

(54) METHOD, DEVICE, AND SYSTEM FOR DATA TRANSMISSION

(71) Applicant: ZTE Corporation, Shenzhen (CN)

(72) Inventors: Xiubin SHA, Shenzhen (CN); Bo DAI, Shenzhen (CN); Jie TAN, Shenzhen (CN); Yuan GAO, Shenzhen (CN); Yin GAO, Shenzhen (CN); Jianxun AI, Shenzhen (CN)

(73) Assignee: ZTE Corporation, Shenzhen, GD (CN)

(21) Appl. No.: 18/981,037

(22) Filed: Dec. 13, 2024

Related U.S. Application Data
(63) Continuation of application No. PCT/CN2022/122252, filed on Sep. 28, 2022.

(51) Int. Cl. H04W 72/1273

(52) U.S. Cl. CPC H04W 72/1273

(57) ABSTRACT

This disclosure relates generally to a method, device, and system for congestion control in a wireless network. One method performed by a first network element is disclosed. The method may include determining, based on DL resource availability, that a DL burst arrival time of a DL burst for a wireless device needs to be adjusted; and transmitting a first message to a core network in the wireless communication system, the first message comprising a DL burst arrival time adjustment indication for the wireless device indicating that a DL burst arrival time of a DL burst for the wireless device needs to be adjusted.

### CROSS-REFERENCE TO RELATED APPLICATION(S)

The present application is a continuation of International Patent Application No. PCT/CN2022/122252, filed Sep. 28, 2022. The contents of International Patent Application No. PCT/CN2022/122252 are herein incorporated by reference in their entirety.

### TECHNICAL FIELD

This disclosure is directed generally to wireless communications, and particularly to a method, device, and system for data transmission and resource scheduling in a wireless network.

### BACKGROUND

Flexible and efficient wireless transmission resource scheduling is critical in the wireless communication network. The ecosystem in a wireless communication network includes more and more applications that require low latency. These applications include Vehicle-to-Vehicle Communication, self-driving, mobile gaming, etc. Data transmission among various network elements in a wireless communication network need to be coordinated, to ensure smooth data transmission which meets a delay budget and requirement, and to improve overall network performance.

### SUMMARY

This disclosure is directed to a method, device, and system for data transmission and resource scheduling in a wireless network.

In some embodiments, a method performed by a first network element is disclosed. The method may include: determining, based on downlink (DL) resource availability, that a DL burst arrival time of a DL burst for a wireless device needs to be adjusted; and transmitting a first message to a core network in the wireless communication system, the first message comprising a DL burst arrival time adjustment indication for the wireless device indicating that a DL burst arrival time of a DL burst for the wireless device needs to be adjusted.

In some embodiments, a method performed by a core network node in a wireless communication system is disclosed. The method may include: receiving a first message from a base station in the wireless communication system, the first message comprising a DL burst arrival time adjustment indication for a wireless device indicating that a DL burst arrival time of a DL burst for the wireless device needs to be adjusted.

In some embodiments, a method performed by a first network element is disclosed. The method may include: determining, based on uplink (UL) resource availability, that a UL burst arrival time of a UL burst for a wireless device needs to be adjusted; and transmitting a first message to a core network in the wireless communication system, the first message comprising a UL burst arrival time adjustment indication for the wireless device.

In some embodiments, a method performed by a core network node in a wireless communication system is disclosed. The method may include: receiving a first message from a base station in the wireless communication system, the first message comprising a UL burst arrival time adjustment indication for a wireless device indicating that a UL burst arrival time of a UL burst for the wireless device needs to be adjusted.

In some embodiments, a method performed by a wireless device is disclosed. The method may include: transmitting a first message to a first network element in the wireless communication system, the first message comprising a UL burst arrival time adjustment indication for the wireless device; and receiving a second message as a response to the first message from the first network element, the second message comprising a confirmed UL burst arrival time information.

In some embodiments, there is a network element or a device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network element.

FIG. 3 shows an example user equipment.

FIG. 4 shows an exemplary implementation of downlink (DL) burst arrival time adjustment.

FIG. 5 shows an exemplary uplink and downlink time domain pattern.

FIG. 6 shows another exemplary implementation of downlink (DL) burst arrival time adjustment.

FIGS. 7-9 show exemplary implementations of uplink (UL) burst arrival time

adjustment.

FIG. 10 shows an exemplary periodic DL traffic and a mismatch between the DL traffic arrival time and the DRX cycle.

FIG. 11 shows an exemplary Application Data Unit (ADU), and mappings from application frame to Internet Protocol (IP) packets.

FIG. 12 shows an exemplary Decoding Time Sequence and Presentation Time Sequence for an ADU.

FIG. 13 shows exemplary QoS sub-flow mapping to Logical Channel.

### DETAILED DESCRIPTION

### Wireless Communication Network

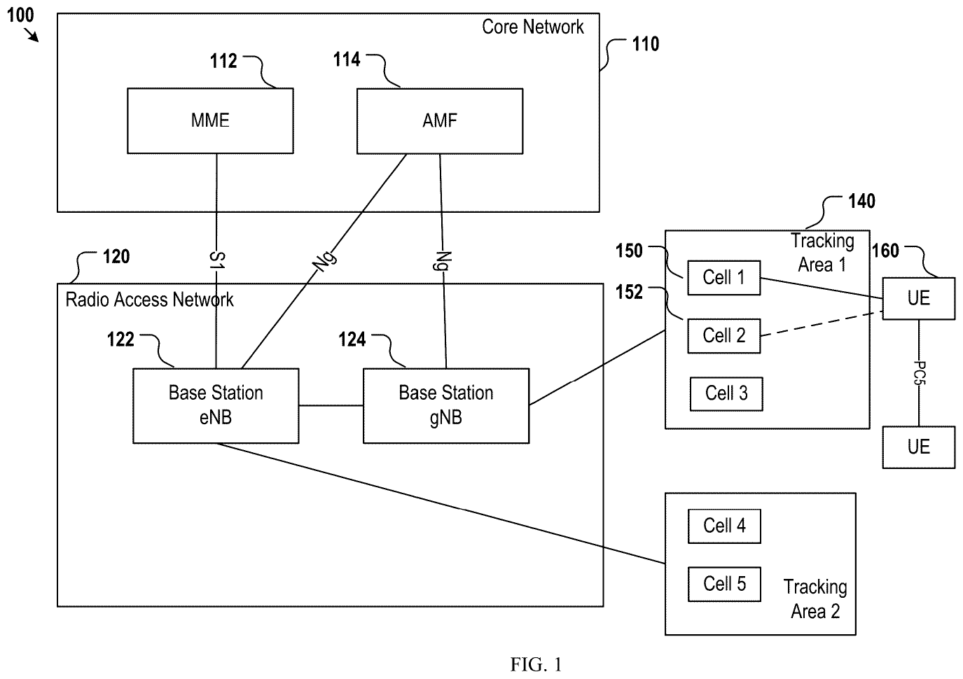

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

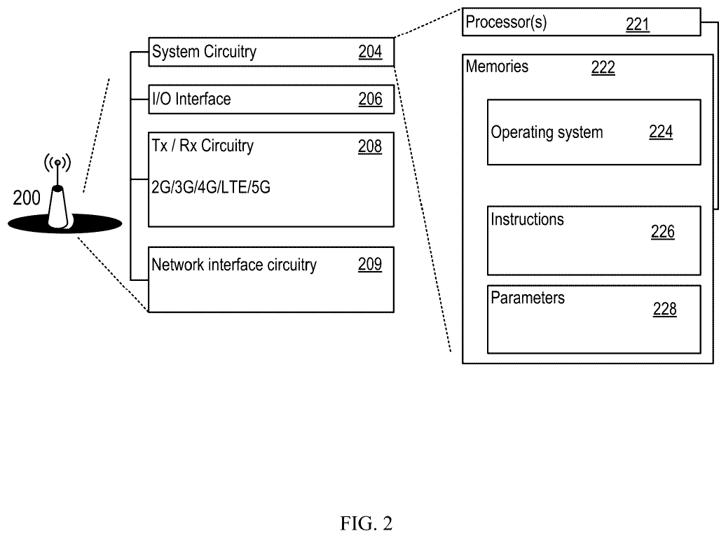

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

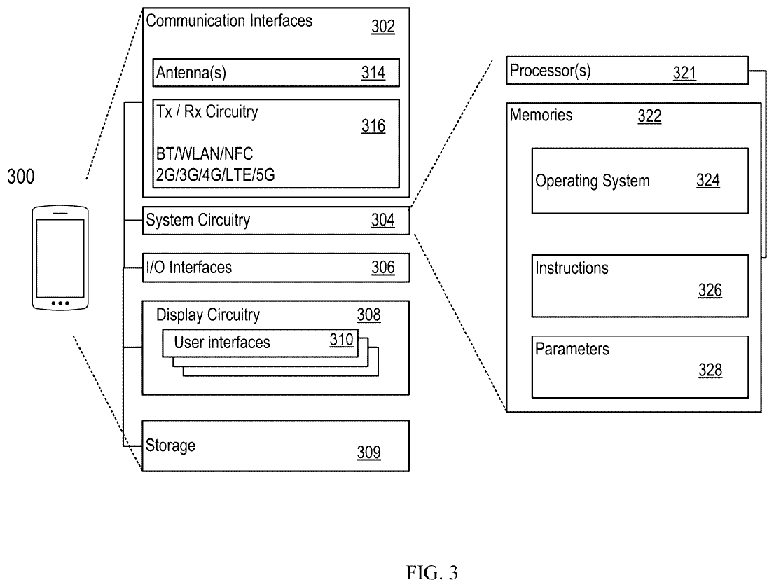

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Data Burst Arrival Time Coordination and Adjustment

In a wireless network, radio resource is shared by various devices, such as user equipments. The radio resource may include time resource and spectrum resource. The delivery or transmission of user data needs to go through various network elements. For example, for downlink traffic, the data may start from a Data Network or an Application, to a core network, to a radio access network (RAN), then it may be delivered by a base station to a UE via radio interface (e.g., Uu interface). For uplink traffic, the data may from a Data Network or an Application running on the UE, and delivered to a base station via air interface, the data will further be routed to the core network by the RAN. To ensure smooth data transmission and improve network performance, coordination effort is needed among these various network elements.

For example, the base station has resource constraint such that only certain resource may be used or allocated to the UE. For example, the data may only be transmitted to the UE at certain time. In this case, it is desirable for the core network to deliver the data to the RAN at a right time which meets the resource constrain on the base station. This means that the base station, once receives the data from the core network, may have radio resource readily available or with minimal delay (e.g., below a threshold), so the data may be transmitted to the UE to meet a delay requirement. Otherwise, the base station may have to buffer the data till the moment when the resource is available, and this will lead to excessive transmission delay and will also increase buffering cost.

To achieve this goal, a base station may communicate with the core network, to coordinate data burst arrival time, so the data burst arrival time match with the resource condition on the base station side. The burst arrival time may be adjusted to be aligned with the radio resource pattern. In this disclosure, various embodiments are described for coordinating the burst arrival time information among various network element in the wireless network. Details on these embodiments are described below.

### Embodiment 1: Downlink Burst Arrival Time Adjustment Trigger by Base Station Without CN Capability Indication

In this embodiment, a base station initiates a request to the core network for adjusting downlink burst arrival time.

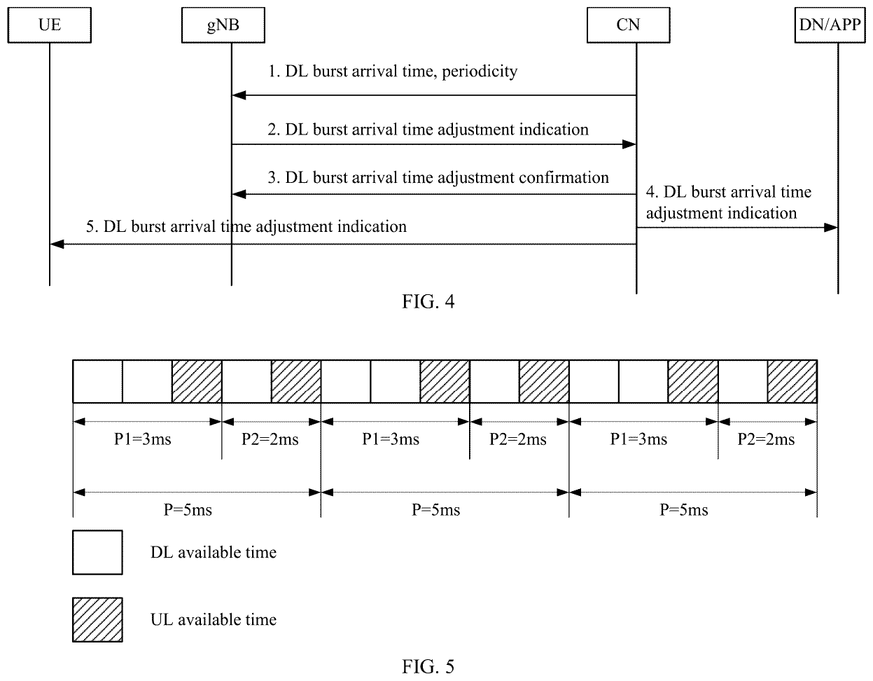

FIG. 4 shows exemplary message flow and interactions among various network elements including base station, core network, UE, and data network or an application running in application layer, for implementing DL burst arrival time adjustment.

step 1: This step is optional. The core network, or a core network node such as an Access and Mobility Management Function (AMF), may send downlink (DL) burst scheduling arrangement for DL data burst of the UE to the base station. The DL burst scheduling arrangement may include a DL burst arrival time and may further include a periodicity for the DL burst.

step 2: The base station may determine whether the DL burst scheduling arrangement is aligned with its own DL resource availability, or DL resource which can be allocated to the UE. The base station may decide to adjust the DL burst arrival time so it may better align with the DL resource availability. The base station may send a DL burst arrival time adjustment indication to the core network (e.g., AMF) via UE associated signaling. The DL Burst arrival time adjustment indication may include as least one of following:
a recommended DL burst arrival time;
a recommended periodicity of the DL burst;
a recommended DL burst arrival time offset relative to a current DL burst arrival time;
a recommended DL burst arrival starting time and a recommended DL burst duration;
a recommended DL burst arrival time pattern which matches with an available downlink radio resource (e.g., Uu interface resources) for the UE;
a cell specific Time Division Duplex (TDD) downlink time domain pattern;
a cell specific TDD uplink and downlink time domain pattern; or
an indication to delete a DL burst arrival time related configuration;
an indication that a current radio resource configuration does not match with a current traffic pattern of the DL burst.

The DL burst arrival time pattern may be represented as a sequence of {DL burst arrival time, time duration, periodicity}, for example, a sequence of {StartTime1, TimeDuration1, Periodicity1}, {StartTime2, TimeDuration2, Periodicity2}.

The DL burst arrival time related configuration may include at least one of: DL burst arrival starting time, periodicity of DL burst.

The DL burst arrival starting time and DL burst duration may be represented as a sequence of {StartTime, TimeDuration}.

The cell specific TDD downlink time domain pattern or cell specific Uplink/Downlink TDD configuration is used to indicate the quasi-periodic DL available time. FIG. 5 shows an example cell specific TDD uplink and downlink time domain pattern. As shown in FIG. 5, there is a big cycle with periodicity P=5 ms (millisecond). In each big cycle, there are two small cycles, with periodicities P1=3 ms and P2=3 ms. The arrange of downlink time assignment and uplink assignment is shown in each small cycle.

In one implementation, the DL burst arrival time related configuration may include the DL arrival time, and a periodicity for the DL burst.

step 3: Upon receiving the DL burst arrival time adjustment indication, if the core network agrees with the recommended DL burst arrival time, it may send a DL burst arrival time adjustment confirmation to the base station via UE associated signaling, to confirm the DL burst arrival time adjustment recommended by the base station. The DL burst arrival time adjustment confirmation may include as least one of following:
a DL burst arrival time;
a periodicity of the DL burst;
a DL burst arrival time offset relative to a current DL burst arrival time;
a DL burst arrival starting time and a DL burst duration;
a DL burst arrival time pattern which matches with an available downlink radio resource for the UE; or
an indication to delete a DL burst arrival time related configuration.

As an example, the DL burst arrival time pattern may be represented as a sequence of {DL burst arrival time, periodicity}.

In one implementation, the DL burst arrival time related configuration may include the DL arrival time, and a periodicity for the DL burst.

step 4: For DL burst, the data network (DN) or the application (APP) running at application layer is driving the data transmission. The core network may also send the DL burst arrival time adjustment indication to the DN or the APP, to trigger the data transmission time adjustment on DN/APP side, so the DL burst arrival time may match the recommended value.

step 5: The core network may also send the DL burst arrival time adjustment indication to UE via Non-Access Stratum (NAS) message. The UE may determine the 5G system (5GS) egress time for DL data based on the DL burst arrival time adjustment indication.

### Embodiment 2: Downlink Burst Arrival Time Adjustment Trigger by Base Station With CN Capability Indication

In this embodiment, the core network may indicate to the base station whether DL burst arrival time adjustment is supported, or the base station may obtain whether DL burst arrival time adjustment is supported in the core network by OAM. Then based on this indication, the base station may initiate a request to the core network for adjusting downlink burst arrival time.

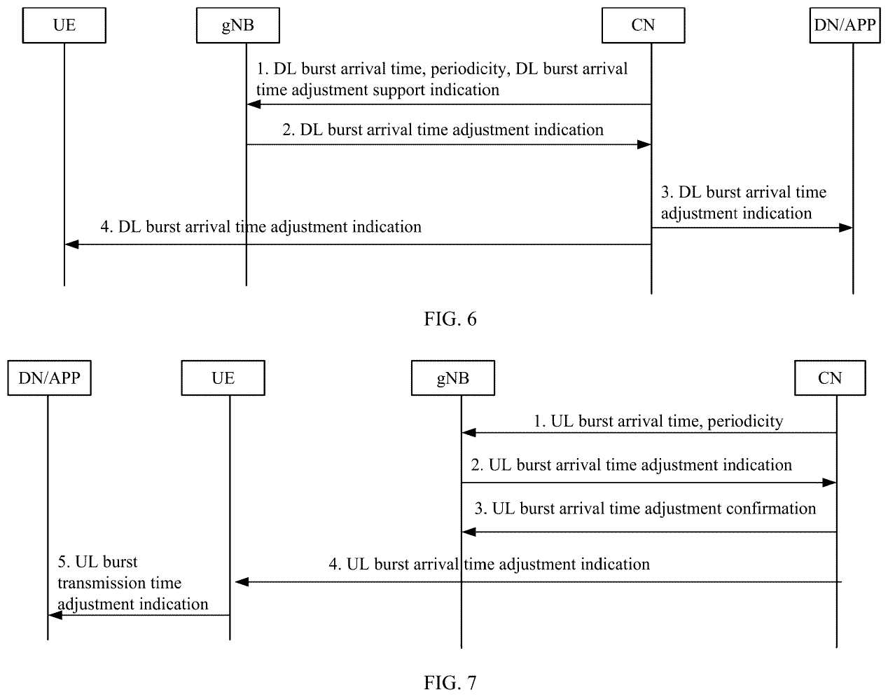

FIG. 6 shows exemplary message flow and interactions among various network elements including base station, core network, UE, and data network or an application running in application layer, for implementing DL burst arrival time adjustment.

step 1: The core network, or a core network node such as an AMF, may send downlink (DL) burst scheduling arrangement for DL data burst of the UE to the base station. The DL burst scheduling arrangement may include a DL burst arrival time and may further include a periodicity for the DL burst. The core network may also send an indication to the base station indicating whether DL burst arrival time adjustment is supported. The granularity of the indication may include a UE level, a base station level, or a core network level.

step 2: The base station may determine whether the DL burst scheduling arrangement is aligned with its own DL resource availability, or DL resource which can be allocated to the UE. The base station may decide to adjust the DL burst arrival time so it may better align with the DL resource availability. The base station may send a DL burst arrival time adjustment indication to the core network (e.g., AMF) via UE associated signaling. The DL Burst arrival time adjustment indication may include as least one of following:
a recommended DL burst arrival time;
a recommended periodicity of the DL burst;
a recommended DL burst arrival time offset relative to a current DL burst arrival time;
a recommended DL burst arrival starting time and a recommended DL burst duration;
a recommended DL burst arrival time pattern which matches with an available downlink radio resource (e.g., Uu interface resources) for the UE;
a cell specific Time Division Duplex (TDD) downlink time domain pattern;
a cell specific TDD uplink and downlink time domain pattern;
an indication to delete a DL burst arrival time related configuration; or
an indication that a current radio resource configuration does not match with a current traffic pattern of the DL burst.

step 3: Different from embodiment 1, when receiving the DL Burst arrival time adjustment indication, the core network does not need to send back a response or confirmation to the base station, as the core network already indicates to the base station that such adjustment is supported.

For DL burst, the data network (DN) or the application (APP) running at application layer is driving the data transmission. The core network may send the DL burst arrival time adjustment indication to the DN or the APP, to trigger the data transmission time adjustment on DN/APP side, so the DL burst arrival time may match the recommended value.

step 4: The core network may further send the DL burst arrival time adjustment indication to UE via NAS message. The UE may determine the 5GS egress time for DL data based on the DL burst arrival time adjustment indication.

### Embodiment 3: Uplink Burst Arrival Time Adjustment Triggered by Base Station Without CN Capability Indication

In this embodiment, a base station initiates a request to the core network for adjusting uplink burst arrival time. The base station may not know whether the core network supports such adjustment before sending this request. Therefore, the base station expects a confirmation from the core network in order to activate the adjustment.

FIG. 7 shows exemplary message flow and interactions among various network elements including base station, core network, UE, and data network or an application running in application layer, for implementing UL burst arrival time adjustment.

step 1: This step is optional. The core network, or a core network node such as an AMF, may send downlink (UL) burst scheduling arrangement for UL data burst of the UE to the base station. The UL burst scheduling arrangement may include a UL burst arrival time and may further include a periodicity for the UL burst.

step 2: The base station may determine whether the UL burst scheduling arrangement is aligned with its own UL resource availability, or UL resource which can be allocated to the UE. The base station may decide to adjust the UL burst arrival time so it may better align with the UL resource availability. The base station may send a UL burst arrival time adjustment indication to the core network (e.g., AMF) via UE associated signaling. The UL Burst arrival time adjustment indication may include as least one of following:
a recommended UL burst arrival time;
a recommended periodicity of the UL burst;
a recommended UL burst arrival time offset relative to a current UL burst arrival time;
a recommended UL burst arrival starting time and a recommended UL burst duration;
a recommended UL burst arrival time pattern which matches with an available uplink radio resource for the UE;
a cell specific Time Division Duplex (TDD) uplink time domain pattern;
a cell specific TDD uplink and downlink time domain pattern;
an indication to delete a UL burst arrival time related configuration; or
an indication that a current radio resource configuration does not match with a current traffic pattern of the UL burst.

The UL burst arrival time pattern may be represented as a sequence of {UL burst arrival time, time duration, periodicity}, for example, a sequence of {StartTime1, TimeDuration1, Periodicity1}, {StartTime2, TimeDuration2, Periodicity2}.

The UL burst arrival starting time and UL burst duration may be represented as a sequence of {StartTime, TimeDuration}.

In one implementation, the UL burst arrival time related configuration may include the UL arrival time, and a periodicity for the UL burst.

step 3: Upon receiving the UL burst arrival time adjustment indication from the base station, if the core network agrees with the recommended UL burst arrival time, it may send a UL burst arrival time adjustment confirmation to the base station via UE associated signaling, to confirm the UL burst arrival time adjustment recommended by the base station. The UL burst arrival time adjustment confirmation may include as least one of following:
a UL burst arrival time;
a periodicity of the UL burst;
a UL burst arrival time offset relative to a current UL burst arrival time;
a UL burst arrival starting time and a UL burst duration;
a UL burst arrival time pattern which matches with an available downlink radio resource for the wireless device; or
an indication to delete a UL burst arrival time related configuration.

In one implementation, the UL burst arrival time related configuration may include the UL arrival time, and a periodicity for the UL burst.

step 4: The core network may further send the UL burst arrival time adjustment indication to the UE via, for example, a NAS message.

step 5: For UL burst, the data network (DN) or the application (APP) running at application layer is driving the data transmission. The APP may include applications running on the UE, such as an online meeting APP, video streaming APP, etc. The UE may send the UL burst transmission time adjustment indication to the DN or the APP, to trigger the data transmission time adjustment on DN/APP side, so the UL burst arrival time may match the recommended value.

### Embodiment 4: Uplink Burst Arrival Time Adjustment Triggered by Base Station With CN Capability Indication

In this embodiment, the core network may indicate to the base station whether UL burst arrival time adjustment is supported. Then based on this indication, the base station may initiate a request to the core network for adjusting uplink burst arrival time.

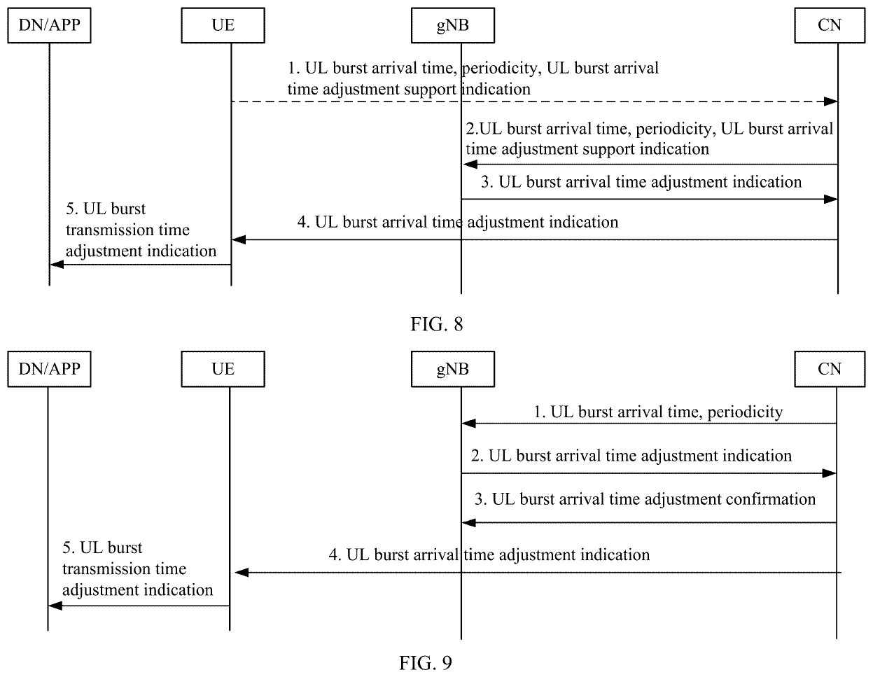

FIG. 8 shows exemplary message flow and interactions among various network elements including base station, core network, UE, and data network or an application running in application layer, for implementing UL burst arrival time adjustment.

step 1: UE may send at least one of: a UL burst arrival time, periodicity for the UL burst, and UL burst arrival time adjustment support indication to the core network, via, for example, a NAS message. In one implementation, UL burst arrival time adjustment Support indication may be indicated implicitly with a range of UL burst arrival time, i.e., UE supports UL burst arriving within this specified range.

step 2: The core network, or a core network node such as an AMF, may send UL burst scheduling arrangement for UL data burst of the UE to the base station. The UL burst scheduling arrangement may include a UL burst arrival time and may further include a periodicity for the UL burst. The core network may also send an indication to the base station indicating whether UL burst arrival time adjustment is supported. The granularity of the indication may include a UE level, a base station level, or a core network level.

step 3: The base station may determine whether the UL burst scheduling arrangement is aligned with its own UL resource availability, or UL resource which can be allocated to the UE. The base station may decide to adjust the UL burst arrival time so it may better align with the UL resource availability. The base station may send a UL burst arrival time adjustment indication to the core network (e.g., AMF) via UE associated signaling. The UL Burst arrival time adjustment indication may include as least one of following:
a recommended UL burst arrival time;
a recommended periodicity of the UL burst;
a recommended UL burst arrival time offset relative to a current UL burst arrival time;
a recommended UL burst arrival starting time and a recommended UL burst duration;
a recommended UL burst arrival time pattern which matches with an available uplink radio resource for the UE;
a cell specific Time Division Duplex (TDD) uplink time domain pattern;
a cell specific TDD uplink and downlink time domain pattern;
an indication to delete a UL burst arrival time related configuration; or
an indication that a current radio resource configuration does not match with a current traffic pattern of the UL burst.

The UL burst arrival time pattern may be represented as a sequence of {UL burst arrival time, time duration, periodicity}, for example, a sequence of {StartTime1, TimeDuration1, Periodicity1}, {StartTime2, TimeDuration2, Periodicity2}.

The UL burst arrival time related configuration may include the UL arrival time, and a periodicity for the UL burst.

The UL burst arrival starting time and UL burst duration may be represented as a sequence of {StartTime, TimeDuration}.

step 4: Different from embodiment 1, when receiving the UL Burst arrival time adjustment indication, the core network does not need to send back a response or confirmation to the base station, as the core network already indicates to the base station that such adjustment is supported.

The core network may send the UL burst arrival time adjustment indication to UE via a NAS message.

step 5: For UL burst, the data network (DN) or the application (APP) running at application layer is driving the data transmission. The APP may include applications running on the UE, such as an online meeting APP, video streaming APP, etc. The UE may send the UL burst transmission time adjustment indication to the DN or the APP, to trigger the data transmission time adjustment on DN/APP side, so the UL burst arrival time may match the recommended value.

### Embodiment 5: Uplink Burst Arrival Time Adjustment Triggered UE

In this embodiment, a UE may initiate a request to the core network for adjusting uplink burst arrival time.

FIG. 9 shows exemplary message flow and interactions among various network elements including base station, core network, UE, and data network or an application running in application layer, for one option to implement UL burst arrival time adjustment.

### Option 1 (As Shown in FIG. 9)

step 1: The UE may have a recommended UL burst transmission configuration, or the UE may already have a UL burst transmission configuration. The UE may inform the core network its current configuration or its preferred UL burst transmission configuration via, for example, a NAS message. UE may include in the message at least one of: a UL burst arrival time, or a periodicity for the UL burst.

Alternatively or additionally, the UE may send a UL burst arrival time adjustment indication to the core network (e.g., AMF) via a NAS message. The UL burst arrival time adjustment indication may include as least one of following:
a recommended UL burst arrival time;
a recommended periodicity of the UL burst;
a recommended UL burst arrival time offset relative to a current UL burst arrival time;
a recommended UL burst arrival starting time and a recommended UL burst duration;
a recommended UL burst arrival time pattern which matches with an available uplink radio resource for the UE;
a cell specific Time Division Duplex (TDD) uplink time domain pattern;
a cell specific TDD uplink and downlink time domain pattern;
an indication to delete a UL burst arrival time related configuration; or
an indication that a current radio resource configuration does not match with a current traffic pattern of the UL burst.

The UL burst arrival time related configuration may include the UL arrival time, and a periodicity for the UL burst.

step 2: Upon receiving the UL burst arrival time adjustment indication from the UE, if the core network agrees with the recommended UL burst arrival time, it may send a UL burst arrival time adjustment confirmation to the UE via a NAS message, to confirm the UL burst arrival time adjustment recommended by the UE. The UL burst arrival time adjustment confirmation may include as least one of following:
a UL burst arrival time;
a periodicity of the UL burst;
a UL burst arrival time offset relative to a current UL burst arrival time;
a UL burst arrival starting time and a UL burst duration;
a UL burst arrival time pattern which matches with an available downlink radio resource for the wireless device; or
an indication to delete a UL burst arrival time related configuration.

step 3: The core network may send the UL burst arrival time adjustment indication to the base station, so the base station may configure/re-configure its UL resource for the UE accordingly.

step 4: For UL burst, the data network (DN) or the application (APP) running at application layer is driving the data transmission. The APP may include applications running on the UE, such as an online meeting APP, video streaming APP, etc. The UE may send the UL burst transmission time adjustment indication to the DN or the APP, to trigger the data transmission time adjustment on DN/APP side, so the UL burst arrival time may match the recommended value.

In option 1, the UE sends the UL burst arrival time adjustment indication to the core network directly using a NAS message. Alternatively, in another option, the UE may use the base station as a relay for sending the UL burst arrival time adjustment indication to the core network. More details are described in option 2.

### Option 2

step 1: The UE may have a recommended UL burst transmission configuration, or the UE may already have a UL burst transmission configuration. The UE may inform the base station its current configuration or its preferred UL burst transmission configuration via, for example, an AS message, such as a Medium Access Control-Control Element (MAC CE) message, a UE dedicated Radio Resource Control (RRC) message, etc. UE may include in the message at least one of: a UL burst arrival time, or a periodicity for the UL burst.

Alternatively or additionally, the UE may send a UL burst arrival time adjustment indication to the base station. The UL burst arrival time adjustment indication is similar as in option 1 of this embodiment.

step 2: The base station may forward the message from UE in step 1 to the core network via a UE associated signaling.

step 3: The core network, if agrees with the recommended UL burst arrival time, may send a UL burst arrival time adjustment confirmation to the base station via a UE associated signaling. Details on the confirmation may be found in option 1 of this embodiment.

step 4: The base station forward the UL burst arrival time adjustment confirmation to the UE via, for example, an AS message, such as a MAC CE message, a UE dedicated RRC message, etc

step 5: For UL burst, the data network (DN) or the application (APP) running at application layer is driving the data transmission. The APP may include applications running on the UE, such as an online meeting APP, video streaming APP, etc. The UE may send the UL burst transmission time adjustment indication to the DN or the APP, to trigger the data transmission time adjustment on DN/APP side, so the UL burst arrival time may match the recommended value.

Exemplarily, the UL burst arrival time may include at least one of following:
a time offset relative to a currently used UL burst arrival time;
a time offset relative to a current time of the wireless communication system when the second message is sent; or
an absolute time of the 5GS comprising at least one of:
   a System Frame Number (SFN);
   a subframe number;
   a slot number;
   a mini slot number;
   a Universal Time Coordinated (UTC) time; or
   an elapsed time duration from a pre-defined time occasion.

### Embodiment 6

In a current wireless network, in order to reduce UE power consumption, a Connected mode Discontinuous Reception (CDRX) may be configured which applies to both periodic or non-periodic traffic. In CDRX mode, the on-duration start occasion is calculated as follows:

$$if the Short DRX cycle is used for a DRX group , \\ and [ ( SFN \times 10 ) + subframe number ] modulo \\ ( drx - ShortCycle ) = ( drx - StartOffset ) modulo \\ ( drx - ShortCycle ) : start drx - onDurationTimer after \\ drx - SlotOffset from the beginning of the subframe . \qquad ( 1 )$$

or

$$if the Long DRX cycle is used for a DRX group , \\ and [ ( SFN \times 10 ) + subframe number ] modulo \\ ( drx - LongCycle ) = drx - StartOffset : start drx - onDurationTimer after \\ drx - SlotOffset from the beginning of the subframe \qquad ( 2 )$$

In the formulas (1) and (2) above, the periodicity for periodic traffic is not considered.

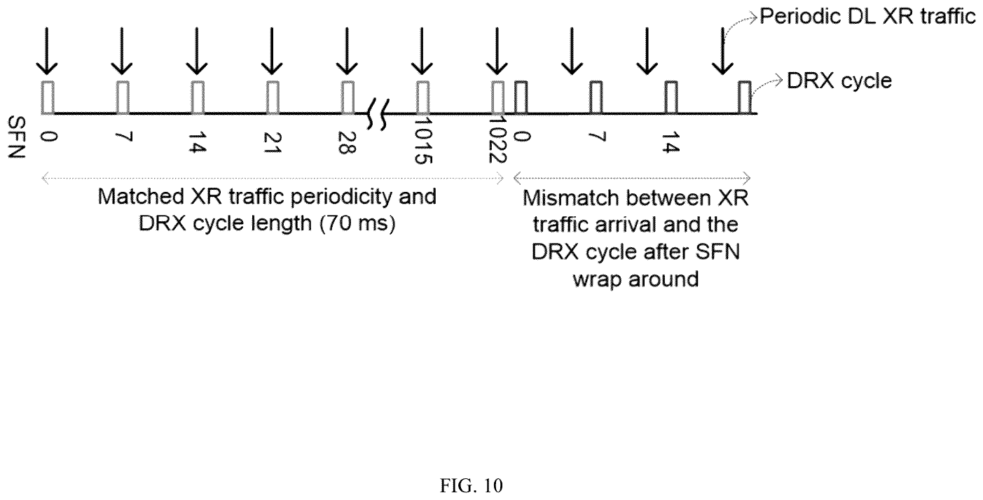

If CDRX is used to align with periodicity of periodic traffic, and the formulas above are used, and if the DRX Cycle in the formulas (i.e., drx-LongCycle or drx-ShortCycle) is not an integer factor of 10240 ms (millisecond), then there be a mismatch between the periodicity of periodic traffic and the DRX ON duration cycle, because of the System Frame Number (SFN) wrap around. This issue may cause the DRX cycle being out of sync with the arrival time of data traffic, for example, eXtended Reality (XR) traffic, as a result of the SFN wrap around. This issue is further illustrated in FIG. 10. In FIG. 10, there is periodic downlink XR traffic. From SFN 0-1023, the periodicity of the XR traffic match with the DRX cycle, which is 70 ms. However, when SFN reset from 1023 to 0 (i.e., SFN wrap around), the periodicity of the XR traffic does not match with the DRX cycle. This will lead to DL transmission failure or transmission delay for the XR service.

In this embodiment, to solve the SFN wrap around issue, the start occasion of CDRX on-duration time can be indicated by network (e.g., Radio Access Network, or core network), and the start of subsequent CDRX on-duration time may be determined based on a periodicity shift relative to the start of the previous adjacent (neighbor) CDRX on-duration time.

In one implementation, after a CDRX is configured, the Medium Access Control (MAC) entity may consider that the Nth CDRX on-duration start at one of:

$$SFN * 10 + subframe = [ ( SFN start time * 10 + subframe start time ) + ceil ( N \times periodicity ) ] modulo 10240 \qquad ( 3 )$$

Where SFNstart time and subframe start time are represented in SFN number and subframe number, respectively, of the first on-duration start occasion when the CDRX was (re-)configured.

or

$$( numberOfSlotsPerFrame \times SFN + slot number in the frame ) = [ ( numberOfSlotsPerFrame \times SFNstart time + slotstart time ) + ceil ( N \times periodicity \times numberOfSlotsPerFrame / 10 ) ] modulo ( 1024 \times numberOfSlotsPerFrame ) \qquad ( 4 )$$

Where SFNstart time and slotstart time are SFN and slot number, respectively, of the first on-duration start occasion when the CDRX was (re-)configured.

or

$$( numberOfSlotsPerFrame \times SFN \times numberOfSymbolsPer Slot + slot number in the frame \times numberOfSymbolsPer Slot + symbol number in the frame ) = [ ( numberOfSlotsPerFrame \times SFNstart time \times numberOfSymbolsPer Slot + slotstart time \times numberOfSymbolsPer Slot + symbolstart time ) + ceil ( N \times periodicity \times numberOfSlotsPerFrame \times numberOfSymbolsPerSlot / 10 ) ] modulo ( 1024 \times numberOfSlotsPerFrame \times numberOfSymbolsPer Slot ) \qquad ( 5 )$$

Where SFNstart time, slotstart time, and symbolstart time are the start time of the SFN, the slot and the symbol, respectively, of the first on-duration start occasion when the CDRX was (re-)configured.

Where the ceil(X) is the ceiling operation to get a minimal integer value that is larger than or equal to X. In one implementation, the ceil( ) operation may be removed from the formula if non-integer CDRX periodicity value is not configured.

In one implementation, the ceil( ) operation may be replaced by FLOOR( ), wherein the FLOOR(X) is the floor operation to get a maximal integer value that is smaller than or equal to X.

### Embodiment 7

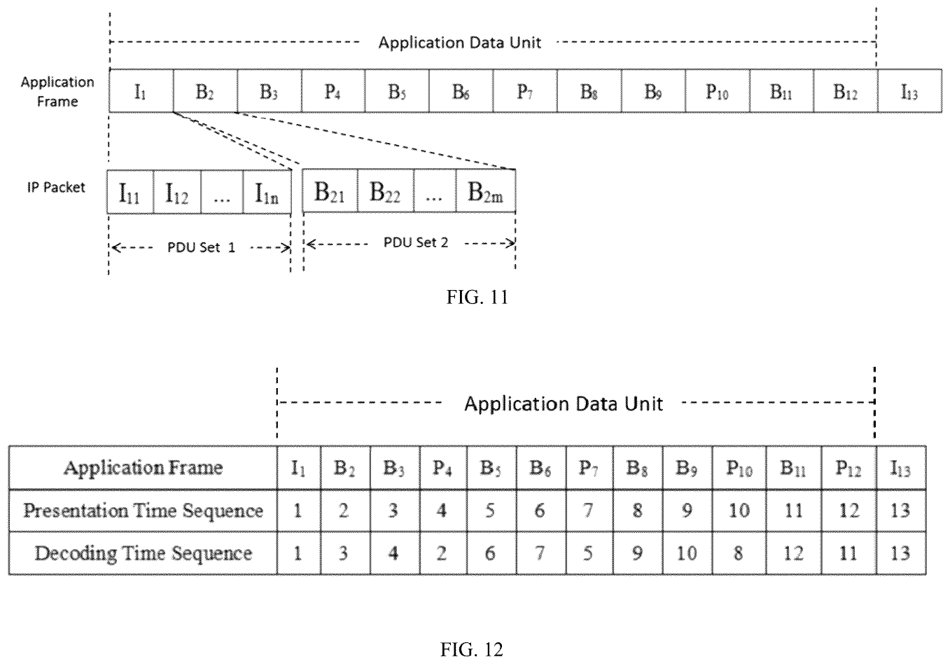

XR service may be a video streaming service with fixed picture frames (e.g., H.264 frame) which may include I-frame, P-frame, B-frame. FIG. 11 shows example application frames and their mapping to IP packets. As shown in FIG. 11, each application frame (e.g., picture frame) may be mapped to multiple IP packets. For example, I-frame I₁ is mapped to IP packet I₁₁ to I₁ₙ, and B-frame B2 is mapped to IP packets B₂₁ to B₂ₘ. Also as shown in FIG. 11, application frames I₁ to B₁₂ form an Application Data Unit (ADU).

Since different picture frames are coded/decode using different coding/decoding schemes, the Quality of Service (QoS) priority or importance of different frames are also different. For example, the Decoding Time Sequence and Presentation Time Sequence for the ADU as shown in in FIG. 11 are shown in FIG. 12.
An I-frame is a keyframe, which stores/transmits all of the data needed to display that frame. Typically, I-frames are interspersed with P-frames and B-frames in a compressed video. The more I-frames that are contained, the better quality the video will be; however, I-frames contain the most number of bits and therefore take up more space on the storage medium and consumes more radio resource to deliver it over Uu interface.
A P-frame is a delta frame, which contains only the data that have changed from the preceding I-frame (such as color or content changes). Because of this, P-frame depend on the preceding I-frame to fill in most of the data.
A B-frame is also a delta frame, which contains only the data that have changed from the preceding frame and are different from the data in the very next frame. Thus, the B-frame depends on the frames preceding and following it to fill in most of the data.

Considering that different application frames have different QoS priority or importance level during ADU decoding, and there are dependencies among different frames, it is beneficial to differentiate these frames in the RAN and weight/consider the difference for radio resource scheduling.

In one implementation, one XR service (e.g. one video streaming) is mapped to one QoS flow, which can indicate the video frame sequence (e.g. PDU set sequence based on PDU set sequence number, if one video frame is map to one PDU set). To differentiate the QoS priority or importance level of PDU sets in one QoS flow, there are two options:

### Option 1: QoS Subflows are Introduced

QoS subflows may also be named as “sub QoS flow”, which is used to differentiate the different QoS attributes (e.g. priority levels) within a same QoS flow.

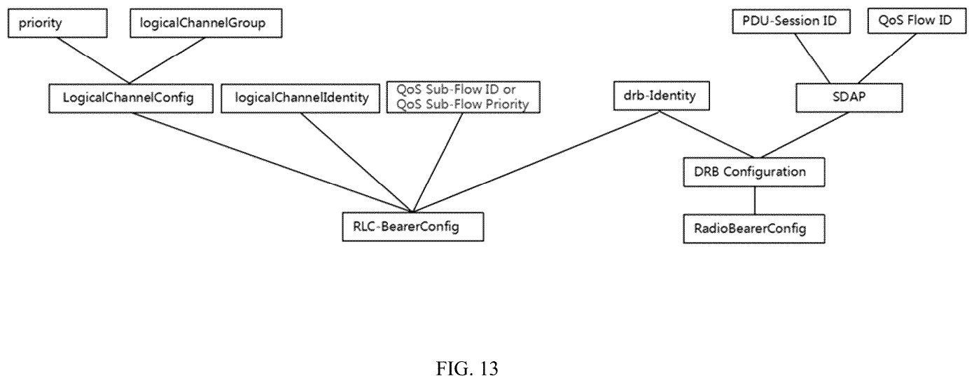

When QoS subflows are introduced, a gNB may map one QoS flow to one Data Radio Bearer (DRB), and then map different QoS subflows of the same DRB to different Logical Channels (LCs) as show in FIG. 13. In FIG. 13, a QoS flow ID is associated with a DRB Identity in DRB configuration, and the DRB Identity is associated with QoS sub-flow ID or QoS sub-flow priority in RLC-BearerConfig. Therefore, one QoS flow may be mapped to different logical channels.

In one implementation, the user plain data PDU is routed from General Packet Radio System (GPRS) Tunneling Protocol User Plane (GTP-U) to Service Data Adaption Protocol (SDAP) entity, then from SDAP entity to Packet Data Convergence Protocol (PDCP) entity, then from PDCP entity to Radio Link Control (RLC) entity, and then from RLC entity to Medium Access Control (MAC) entity. Radio resource scheduling may be performed in MAC entity.

Considering that one PDCP entity is associated with a DRB, if different QoS subflows of same DRB are mapped to different logical channels, the PDCP entity should be aware of the QoS subflow information, so that it can properly route PDCP PDUs with different QoS subflows to different logical channels.

In order for the PDCP entity to be aware of the QoS subflow information, QoS sub-flow ID or QoS sub-flow priority should be included in a SDAP PDU (e.g., by adding a SDPA header which includes a QoS sub-flow ID and/or a QoS sub-flow priority field).

### Option 2: Only Priority Level or Importance Indication is Introduced in GTP-U Header

In one implementation, the user plain data PDU is routed from GTP-U (e.g., in DL PDU SESSION INFORMATION (PDU Type 0) format) to SDAP entity, then from SDAP entity to PDCP entity, then from PDCP entity to RLC entity, and then from RLC entity to MAC entity. Radio resource scheduling are performed in MAC entity.

Considering that one PDCP entity is associated with a DRB, if QoS sub-flow is not introduced, one DRB usually is mapped to one logical channel.

If priority level or importance indication is introduced in GTP-U header, so that MAC entity can be aware of the priority level or importance indication information for radio resource scheduling, the priority level or importance indication should be available in the MAC entity. This can be implemented using one of the following solutions:

Solution 1: Priority level or importance indication are included in XnAP and/or F1AP user plane packet header (e.g., GTP-U header) to deliver the priority level or importance indication information between different RAN network elements (e.g. between gNBs and/or between gNB-CU and gNB-DU). In a RAN network element, the priority level or importance indication delivery can be based on gNB implementation and/or UE implementation.

Solution 2: priority level or importance indication is included in SDAP data PDU (e.g., by adding a SDPA header which includes QoS sub-flow ID or QoS sub-flow priority field), and then included in PDCP data PDU (e.g., priority level or importance indication is included in the header of PDCP data PDU), and further included in RLC data PDU (e.g. priority level or importance indication is included in the header of RLC PDU).

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a first network element in a wireless communication system, the method comprising:
determining, based on downlink (DL) or uplink (UL) resource availability, that a DL or UL burst arrival time of a DL or UL burst for a wireless device needs to be adjusted; and
transmitting a first message to a core network in the wireless communication system, the first message comprising a DL or UL burst arrival time adjustment indication for the wireless device indicating that a DL or UL burst arrival time of a DL or UL burst for the wireless device needs to be adjusted.

2. The method of claim 1,
wherein the DL burst arrival time adjustment indication comprises at least one of:
a recommended DL burst arrival time;
a recommended periodicity of the DL burst;
a recommended DL burst arrival time offset relative to a current DL burst arrival time;
a recommended DL burst arrival starting time and a recommended DL burst duration;
a recommended DL burst arrival time pattern which matches with an available downlink radio resource for the wireless device;
a cell specific Time Division Duplex (TDD) downlink time domain pattern;
a cell specific TDD uplink and downlink time domain pattern; or
an indication that a current radio resource configuration does not match with a current traffic pattern of the DL burst; or
wherein the UL burst arrival time adjustment indication comprises at least one of:
a recommended UL burst arrival time;
a recommended periodicity of the UL burst;
a recommended UL burst arrival time offset relative to a current DL or UL burst arrival time;
a recommended UL burst arrival starting time and a recommended DL or UL burst duration;
a recommended UL burst arrival time pattern which matches with an available downlink or uplink radio resource for the wireless device;
a cell specific Time Division Duplex (TDD) uplink time domain pattern;
a cell specific TDD uplink and downlink time domain pattern; or
an indication that a current radio resource configuration does not match with a current traffic pattern of the DL burst.

3. The method of claim 1, wherein the first message comprises a User Equipment (UE) associated signaling message.

4. The method of claim 1, further comprising:
receiving a second message from the core network as a response to the first message, the second message comprising a DL or UL burst arrival time confirmation, and
the DL burst arrival time confirmation comprising at least one of:
a DL burst arrival time;
a periodicity of the DL burst;
a DL burst arrival time offset relative to a current DL burst arrival time;
a DL burst arrival starting time and a DL burst duration;
a DL burst arrival time pattern which matches with an available downlink radio resource for the wireless device; or
an indication to delete a DL burst arrival time related configuration; or
the UL burst arrival time confirmation comprising at least one of:
a UL burst arrival time;
a periodicity of the UL burst;
a UL burst arrival time offset relative to a current DL or UL burst arrival time;
a UL burst arrival starting time and a DL or UL burst duration;
a UL burst arrival time pattern which matches with an available downlink radio resource for the wireless device; or
an indication to delete a UL burst arrival time related configuration.

5. The method of claim 1, wherein:
before transmitting the first message to the core network, the method further comprises:
receiving, from the core network, an indicator indicating whether a DL or UL burst arrival time adjustment is supported by the core network; and
transmitting the first message to a core network comprises:
in response to the indicator indicating that the DL or UL burst arrival time adjustment is supported by the core network, transmitting the first message to the core network.

6. The method of claim 1, wherein a reception of the first message by the core network triggers the core network to perform at least one of:
transmitting the DL burst arrival time adjustment indication to an entity providing the DL burst for the wireless device, the entity comprising at least one of: a data network; or an application layer; or
transmitting the DL burst arrival time adjustment indication to the wireless device.

7. The method of claim 1, wherein transmitting the first message to the core network comprises:
transmitting the first message to an Access and Mobility Management Function (AMF) of the core network via a UE associated signaling.

8. The method of claim 1, wherein the first network element comprises a base station, the base station comprising one of:
a gNodeB (gNB);
an eNodeB (eNB);
an ng-eNodeB (ng-eNB); or
a NodeB.

9. A method for wireless communication, performed by a core network node in a wireless communication system, the method comprising:
receiving a first message from a base station in the wireless communication system, the first message comprising a DL or UL burst arrival time adjustment indication for a wireless device indicating that a DL or UL burst arrival time of a DL or UL burst for the wireless device needs to be adjusted.

10. The method of claim 9,
wherein the DL burst arrival time adjustment indication comprises at least one of:
a recommended DL burst arrival time;
a recommended periodicity of the DL burst;
a recommended DL burst arrival time offset relative to a current DL burst arrival time;
a recommended DL burst arrival starting time and a recommended DL burst duration;
a recommended DL burst arrival time pattern which matches with an available downlink radio resource for the wireless device;
a cell specific Time Division Duplex (TDD) downlink time domain pattern;
a cell specific TDD uplink and downlink time domain pattern; or
an indication that a current radio resource configuration does not match with a current traffic pattern of the DL burst; or
wherein the UL burst arrival time adjustment indication comprises at least one of:
a recommended UL burst arrival time;
a recommended periodicity of the UL burst;
a recommended UL burst arrival time offset relative to a current DL or UL burst arrival time;
a recommended UL burst arrival starting time and a recommended DL or UL burst duration;
a recommended UL burst arrival time pattern which matches with an available downlink radio resource for the wireless device;
a cell specific Time Division Duplex (TDD) uplink time domain pattern;
a cell specific TDD uplink and downlink time domain pattern; or
an indication that a current radio resource configuration does not match with a current traffic pattern of the UL burst.

11. The method of claim 9, further comprising:
transmitting the DL burst arrival time adjustment indication to an entity providing the DL burst for the wireless device, the entity comprising at least one of: a data network; or an application layer.

12. The method of claim 9, further comprising:
transmitting the DL or UL burst arrival time adjustment indication to the wireless device.

13. The method of claim 9, wherein:
before receiving the first message from the base station, the method further comprises:
transmitting, to the base station, a first indicator indicating whether a DL or UL burst arrival time adjustment is supported by the core network node.

14. The method of claim 13, further comprising:
transmitting a second message to the base station as a response to the first message, the second message comprising a DL or UL burst arrival time confirmation, and
the DL burst arrival time confirmation comprising at least one of:
a DL burst arrival time;
a periodicity of the DL burst;
a DL burst arrival time offset relative to a current DL burst arrival time;
a DL burst arrival starting time and a DL burst duration;
a DL burst arrival time pattern which matches with an available downlink radio resource for the wireless device; or
an indication to delete a DL burst arrival time related configuration; or
the UL burst arrival time confirmation comprising at least one of:
a UL burst arrival time;
a periodicity of the UL burst;
a UL burst arrival time offset relative to a current DL or UL burst arrival time;
a UL burst arrival starting time and a DL or UL burst duration;
a UL burst arrival time pattern which matches with an available downlink or uplink radio resource for the wireless device; or
an indication to delete a UL burst arrival time related configuration.

15. The method of claim 9, wherein the core network node comprises an AMF.

16-19. (canceled)

20. The method of claim 1, wherein:
a reception of the first message by the core network triggers the core network to transmit the UL burst arrival time adjustment indication to the wireless device; and
a reception of the UL burst arrival time adjustment indication by the wireless device triggers the wireless device to transmit the UL burst arrival time adjustment indication to an entity providing the UL burst for the wireless device, the entity comprising at least one of: a data network; or an application layer.

21-26. (canceled)

27. The method of claim 13, wherein before transmitting the first indicator to the base station, the method further comprises:
receiving a second indicator from the wireless device indicating whether the UL burst arrival time adjustment is supported by the wireless device.

28-35. (canceled)

36. A device for wireless communication comprising a memory for storing computer instructions and a processor in communication with the memory, wherein, when the processor executes the computer instructions, the processor is configured to implement a method comprising:
determining, based on downlink (DL) or uplink (UL) resource availability, that a DL or UL burst arrival time of a DL or UL burst for a wireless device needs to be adjusted; and
transmitting a first message to a core network in a wireless communication system, the first message comprising a DL or UL burst arrival time adjustment indication for the wireless device indicating that a DL or UL burst arrival time of a DL or UL burst for the wireless device needs to be adjusted.

37. A computer program product comprising a non-transitory computer-readable program medium with computer code stored thereupon, the computer code, when executed by one or more processors, causing the one or more processors to implement a method comprising:
determining, based on downlink (DL) or uplink (UL) resource availability, that a DL or UL burst arrival time of a DL or UL burst for a wireless device needs to be adjusted; and
transmitting a first message to a core network in a wireless communication system, the first message comprising a DL or UL burst arrival time adjustment indication for the wireless device indicating that a DL or UL burst arrival time of a DL or UL burst for the wireless device needs to be adjusted.
